(19) United States
(12) Patent Application Publication
(10) Pub. No.: US 2014/0137531 A1
(43) Pub. Date: May 22, 2014

(54) PICK-UP DEVICE EQUIPPED WITH IMPROVED BEARINGS AND AGRICULTURAL MACHINE EQUIPPED WITH SUCH A DEVICE

(71) Applicants: Christian Gantzer, Woustwiller (FR); Jean-Pierre Petain, Westhoffen (FR)

(72) Inventors: Christian Gantzer, Woustwiller (FR); Jean-Pierre Petain, Westhoffen (FR)

(73) Assignee: KUHN S.A., Saverne (FR)

(21) Appl. No.: 14/232,447

(22) PCT Filed: Jul. 9, 2012
(86) PCT No.: PCT/FR12/51616

§ 371 Date: Jan. 13, 2014

(30) Foreign Application Priority Data
Jul. 13, 2011 (FR) 11 56369

(51) Int. Cl. A01D 89/00

(52) U.S. Cl. CPC A01D 89/002
USPC 56/379

(57) ABSTRACT

A pick-up device, usable by an agricultural machine, includes a rotating part including at least one support arm, to which are attached raking and picking up tools and which is configured to pivot about a rotation axis with respect to the rotating part by at least first and second bearings, the at least first and second bearings each including an outer ring rigidly fastened to the rotating part, and with respect to which outer ring the support arm can pivot about the rotation axis. The first bearing includes an inner ring configured to pivot about the rotation axis with respect to the outer ring and rigidly fastened to the support arm. A stop mechanism connects the inner ring to the outer ring, and limits displacement of the support arm with respect to the rotating part in a direction substantially parallel to the rotation axis to a small or nil value.

The present invention relates to a pick-up device comprising tools for raking and picking up products lying on the ground and which is intended to be mounted on an agricultural machine. The pick-up device comprises a rotating part equipped with at least a support arm, the raking and pick-up tools being attached to the at least one support arm, the at least one support arm being rotatable about a rotation axis with respect to the rotating part by means of at least a first bearing and a second bearing, the at least first and second bearings each comprising an outer ring rigidly fastened to the rotating part and with respect to which outer ring the support arm can pivot about the rotation axis.

Such a pick-up device is known, since it is fitted on the “900” variant of the machine offered for sale by the company KUHN under the name “MERGE-MARX” (registered trademark). This machine is intended for picking up mown plants lying on the ground and for depositing the picked up plants in one or several swaths. On this machine, the pick-up device includes raking and pick-up tools having the form of forks. The pick-up device also comprises a rotating part constructed as a cylinder equipped with at least two flanges. The flanges are similar to rings concentric with the cylinder and which are welded to the cylinder at some distance from one another along the cylinder axis. The rotating part comprises several support arms to which the fork holders are attached. The forks are screwed on the fork holders. Each support arm is connected to the rotating part by means of at least two bearings, and each bearing is carried by a flange. In addition, one end of each support arm is equipped with a cam carrying a roller that rolls in a cam track. Thus, each support arm can pivot about a rotation axis which is substantially parallel to the rotation axis of the rotating part, and its pivoting is controlled by the cam. For the sake of clarity, each flange is described as having one face referred to as the inner face and one face referred to as the outer face, which are defined as follows. The inner faces of two consecutive flanges are the two annular faces that face toward one another. The outer face is the annular face on the opposite side to the inner face of the corresponding flange. Each bearing comprises an outer ring and a spacer. The outer ring has a bore in which the support arm can pivot. The spacer is formed by a hollow cylinder in which the support arm can pivot. Each outer ring is fastened to the inner face of the corresponding flange and extends towards the inner face of the opposite flange. Each spacer extends between the outer face of the corresponding flange and the fork holder situated closest to the outer face. Thus, one spacer limits or even prevents the displacement of the support arm in a direction parallel to the rotation axis, while the other spacer limits or even prevents the displacement in the opposite direction. When used together, the two spacers limit or even prevent the displacement of the support arm parallel to the rotation axis.

A drawback of the pick-up device described above is that the various components must be manufactured with extreme precision to ensure on one hand that the flanges, spacers and fork holders can be mounted as described above, and on another hand that there is absolutely no movement of the support arm parallel to the rotation axis. This requirement increases the cost price of the machine. Accordingly, if the spacer is too long, it cannot be fitted between the flange and the fork holder. On another hand, if the spacer is too short, a space will remain between the flange and the fork holder, and the support arm will thus be able to move parallel to the rotation axis. Similarly, if the fork holder is not manufactured within the set tolerances or if it is attached at the wrong place on the support arm, it will impede the assembly of the next spacer or backlash will remain. Finally, the assembly of the support arm by means of the two bearings is hyperstatic, since one bearing must prevent movement parallel to the rotation axis in one direction and the other bearing must prevent such movement in the opposite direction.

The object of the present invention is to provide a pick-up device that does not have the aforementioned drawbacks.

To this end, an important feature of the invention consists in the fact that at least the first bearing comprises an inner ring, the inner ring can pivot about the rotation axis with respect to the outer ring, the inner ring is rigidly fastened to the support arm, a stop means connects the inner ring to the outer ring, and the stop means limits the displacement of the support arm with respect to the rotating part in a direction substantially parallel to the rotation axis, to a small or nil value.

It is the shape of the inner ring, not the one of the support arm, which conforms to the geometry of the stop means. Thus, the support arm may advantageously be chosen from a range of moderately priced standard profiles. Moreover, since it is a small component, the inner ring may easily take a shape of more or less complexity as determined by the stop means, and can easily be subjected to thermal treatment. In the given form, the stop means limits the displacement of the support arm in both directions parallel to the rotation axis. The other bearings advantageously do not need to be equipped with stop means. The assembly of the support arm is therefore isostatic.

Other features and advantages of the invention will become apparent from the following description with reference to the attached drawings, which illustrate by way of non-limiting example, several embodiments of the pick-up device according to the invention.

### IN THESE DRAWINGS

FIG. 1 is a top view of an agricultural machine hitched to a tractor and equipped with several pick-up devices according to the invention;

FIG. 2 is a perspective view of an embodiment of a pick-up device according to the invention;

FIG. 3 is a part view of the pick-up device according to the invention as represented in the embodiment of FIG. 2;

FIG. 4 is a part view of the pick-up device of FIG. 3, along line IV-IV in FIG. 3;

FIG. 5 is a cross-sectional view of the first bearing in an exemplary embodiment along line V-V in FIG. 4;

FIG. 6 is a cross-sectional view of the second bearing in another exemplary embodiment along line VI-VI in FIG. 4;

FIG. 7 is a cross-sectional view of the first bearing according to a first embodiment variant, along line VII-VII in FIG. 3;

FIG. 8 is a cross-sectional view of the first bearing according to a second embodiment variant, along line VIII-VIII in FIG. 3;

FIG. 9 is a cross-sectional view of the first bearing according to a third embodiment variant, along line IX-IX in FIG. 3;

FIG. 10 is a cross-sectional view of the first bearing according to a fourth embodiment variant, along line X-X in FIG. 3;

FIG. 11 is a cross-sectional view of the first bearing according to a fifth embodiment variant, along line XI-XI in FIG. 4

FIG. 12 is a cross-sectional view of the first bearing according to a sixth embodiment variant, along line XII-XII in FIG. 3;

FIG. 13 is a cross-sectional view of the first bearing according to a seventh embodiment variant, along line XIII-XIII in FIG. 4.

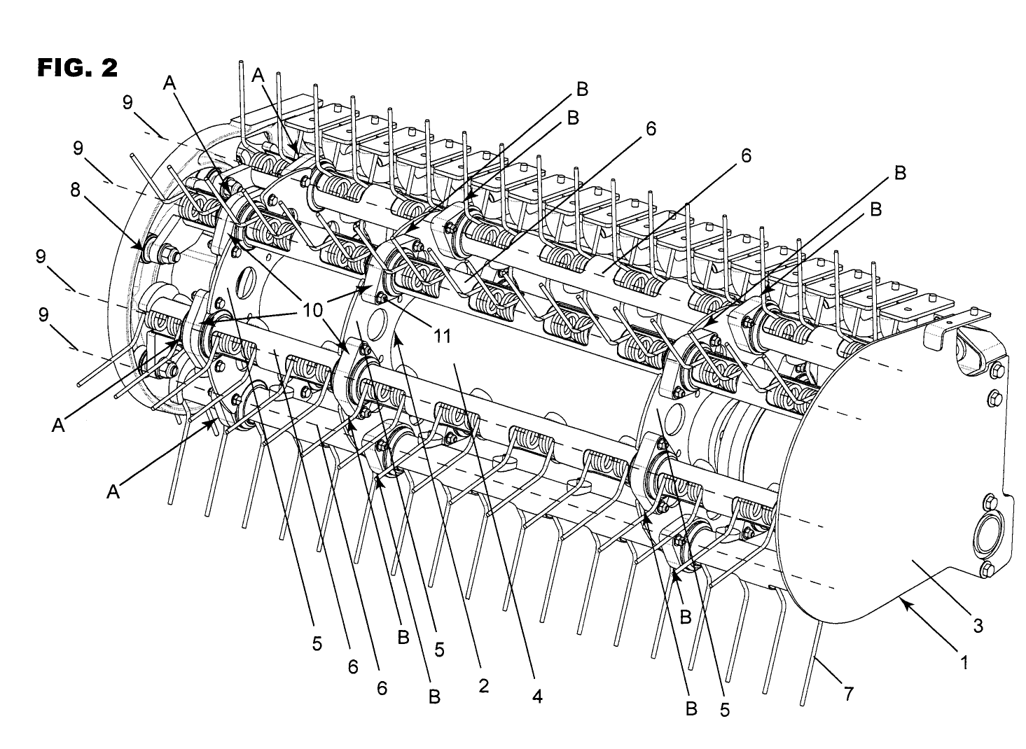

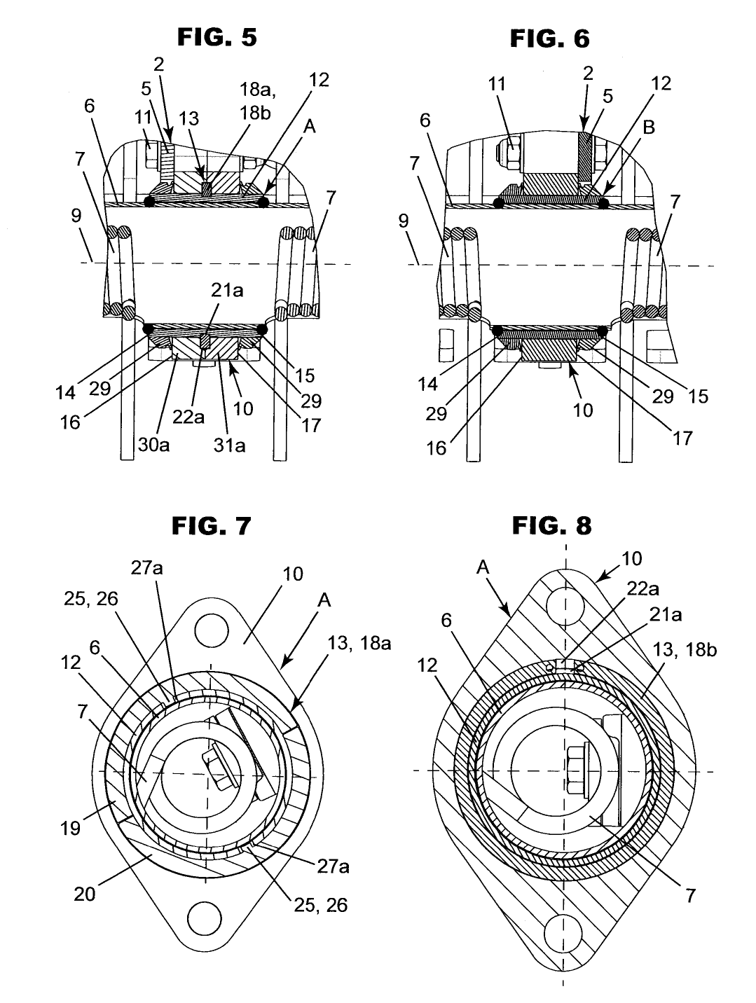

As is shown in FIG. 2, the pick-up device (1) according to the invention comprises a rotating part (2) and a frame (3). The rotating part (2) is made of a cylinder (4) which is in pivot connection with the frame (3). Several flanges (5) are attached to the cylinder (4). The flanges (5) are welded to the cylinder (4) at some distance from one another along the axis of the cylinder (4). The flanges (5) are provided with openings close to their periphery to allow the support arms (6) to pass through. The support arms (6) are made from hollow tubes and carry several forks (7). In the embodiment of FIG. 2, the forks are controlled by a cam device (8). The cam device (8) comprises a cam that is rigidly fastened to the support arm (6), a roller which is in pivot connection with one end of the cam, and a cam track that is rigidly fastened to the frame (3) and in which the roller can roll. Each such support arm (6) can pivot about a rotation axis (9) with respect to the rotating part (2) by means of at least a first bearing (A), shown particularly in FIG. 5, and a second bearing (B), shown in detail in FIG. 6. In the embodiment of FIG. 2, each support arm (6) is supported by a bearing (A) and two bearings (B). The bearings (A) and (B) each have an outer ring (10) that is rigidly fastened to the corresponding flange (5) via bolts (11) that are visible in FIG. 2. The support arm (6) passes through the outer ring (10) in such manner that the support arm can pivot with respect to the outer ring (10) about the rotation axis (9).

At least the bearing (A) comprises an inner ring (12), the outer diameter of which is substantially fitted to the inner diameter of the corresponding outer ring (10), such that the inner ring (12) can pivot with respect to the outer ring (10) about the rotation axis (9). The inner ring (12) is rigidly fastened to the support arm (6), by welding for example. The inner ring (12) is designed to accommodate a stop means (13). Thus, it is the shape of the inner ring (12) that adjusts to the geometry of the stop means (13), and not that of the support arm (6). The support arm (6) being of the rod type, it may advantageously be chosen from a range of moderately priced standard profiles. It is also easier to achieve a complex shape with a small component such as the inner ring (12) than with a very long element such as the support arm (6). In addition, the inner ring (12) is advantageously heat-treated to improve wear resistance. With the inner ring (12) present, there is no longer any need to provide heat treatment for the support arm (6), either in its entirety or in the vicinity of the outer ring (10). Furthermore, heat treatment is easier to perform on a small component such as the inner ring (12), than on a very long element such as the support arm (6). The stop means (13) connects the inner ring (12) to the outer ring (10) and limits the displacement of the support arm (6) with respect to the rotating part (2) in a direction substantially parallel to the rotation axis (9), to a small or nil value. The stop means (13) is preferably connected only to the bearing (A), while the bearing (B) are free from any stop means (13), so that the assembly of the support arm (6) is rendered isostatic. In this case, backlash in a direction parallel to the rotation axis (9) can be controlled merely by adapting the specific geometries of the outer ring (10) and the inner ring (12) of the bearing (A), and that of the connected stop means (13).

The inner ring (12) advantageously extends between two faces (14, 15), while the outer ring extends between two faces (16, 17). The stop means (13) is preferably arranged between the two closest of the faces (14, 15, 16, 17) in a direction substantially parallel to the rotation axis (9). This means that in the exemplary embodiment of FIG. 5, in which the inner ring (12) is wider than the outer ring (10), the stop means (13) is located between the faces (16, 17) of the outer ring (10).

According to a first embodiment variant shown in FIG. 7, the stop means (13) is preferably made of a two-part segment (18a) comprising two parts (19, 20). Each of the parts (19, 20) engages on one hand in a groove (21a) formed in the inner ring (12) and on another hand in a groove (22a) formed in the outer ring (10).

The second embodiment variant, shown in FIG. 8, differs from the first one in that the stop means (13) is made of an open segment (18b).

In both aforementioned embodiment variants, after removal of the outer ring (10) it is easy to take the segment (18a, 18b) out of the groove (21a) formed in the inner ring (12). In addition, because of its substantially annular shape, the segment (18a, 18b), is able to withstand considerable axial forces.

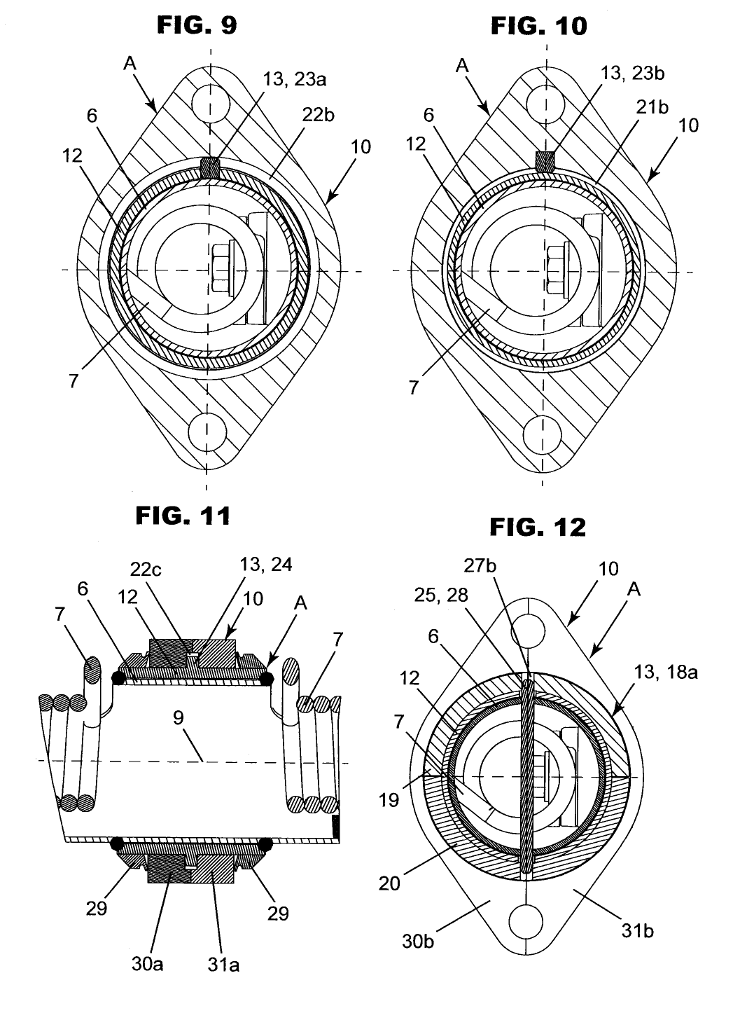

According to the third embodiment variant shown in FIG. 9, the stop means (13) is made of a pin (23a) rigidly fastened to the inner ring (12), which pin (23a) engages in a groove (22b) formed in the outer ring (10).

According to the fourth embodiment variant shown in FIG. 10, the stop means (13) is made of a pin (23b) rigidly fastened to the outer ring (10), which pin (23b) engages in a groove (21b) formed in the inner ring (12).

As may be seen in FIG. 11, a fifth embodiment variant provides that the stop means (13) is made of a shoulder (24) on the inner ring (12), which shoulder (24) engages in a groove (22c) formed in the outer ring (10).

The segment (18a, 18b) preferably includes an anti-rotation means (25). The anti-rotation means (25) limits pivoting backlash of the segment (18a, 18b) about an axis substantially parallel to the rotation axis (9) to a small or nil value. This feature prevents premature wear of the segment (18a, 18b) due to friction in the grooves (21a, 22a).

The anti-rotation means (25) may advantageously be made of a teat (26) rigidly fastened to the segment (18a, 18b) and which engages in a hole (27a) made in the inner ring (12). This feature is shown in FIG. 7.

A sixth embodiment variant, shown in FIG. 12 provides that the anti-rotation means (25) is made of a pin (28) that passes through the segment (18a, 18b) and engages in a hole (27b) made in the inner ring (12).

According to FIG. 6, it is preferably provided that at least the second bearing (B) comprises an inner ring (12) that can pivot with respect to the outer ring (10) about the rotation axis (9) and is rigidly fastened to support arm (6). In the embodiment shown in FIG. 2, all the bearings (B) comprise the inner ring (12). The inner ring can be advantageously heat-treated for improved resistance to wear.

In addition, the inner ring (12) can freely move in the outer ring (10) in a direction substantially parallel to the rotation axis (9). This feature is shown clearly in FIG. 6.

At least one of the at least one first bearing (A) and second bearing (B) advantageously has two seals (29), and each of the two seals (29) rests against the outer ring (10) of the at least one first bearing (A) or second bearing (B). The two seals (29) can particularly be seen in FIGS. 5 and 6. Each of the two seals (29) can rest either against the inner ring (12) or against the support arm (6). This prevents dirt from infiltrating the corresponding bearing (A, B) and increases its service life. Also, in the case of a lubricated bearing (A, B), the two seals (29) reduce losses of lubricant.

Each of the two seals (29) preferably rests against the inner ring (12) of the at least one first bearing (A) or second bearing (B). This feature is shown in FIGS. 5 and 6.

As shown in FIG. 5, the outer ring (10) of at least one of the at least first bearing (A) and second bearing (B) preferably comprises two sections (30a, 31a) which meet in a plane substantially perpendicular to the rotation axis (9). This feature is particularly advantageous when the corresponding bearing (A, B) is equipped with the stop means (13). In fact, this ensures a rapid disassembly/reassembly of the outer ring (10).

Alternatively, the same benefit can be obtained if the outer ring (10) of at least one of the at least first bearing (A) and second bearing (B) comprises two sections (30b, 31b) that meet in a plane substantially parallel to the rotation axis (9). This feature is shown in FIG. 12.

The outer ring (10) of at least one of the at least first bearing (A) and second bearing (B) is preferably made from a self-lubricating material. This may be in particular lubricated PA6 plastic. The low intrinsic friction coefficient of PA6 is further reduced by the fact that it is lubricated. This feature advantageously eliminates the need for the user to carry out tedious lubricating operations. Moreover, the self-lubricating material becomes worn slowly, thus increasing the service life of the pick-up device (1) and reducing the replacement frequency of the outer ring (10).

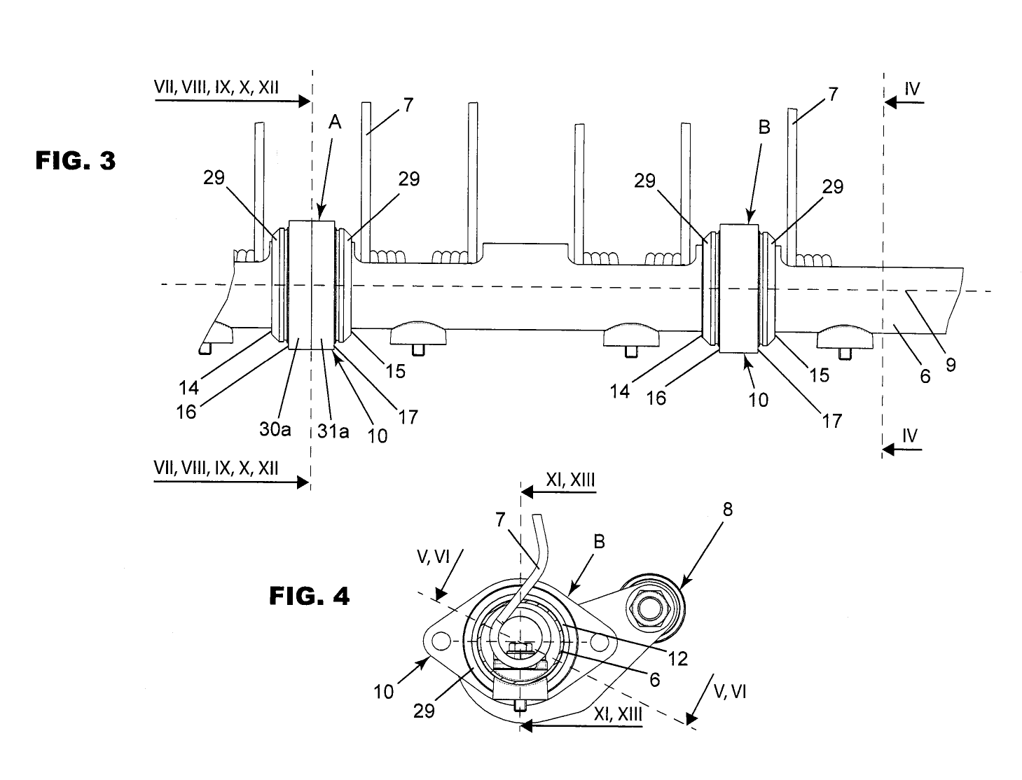

The inner ring (12) of at least one of the at least first bearing (A) and second bearing (B) may be a part attached to the support arm (6). This feature is shown in FIGS. 2 to 12. Since the support arm (6) is of the rod type, it may advantageously be chosen from a range of moderately priced standard profiles. It is also easier to make a small component such as the inner ring (12) in a complex shape than a long element such as the support arm (6). Moreover, the inner ring (12) is advantageously heat-treated to render it more resistant to wear. The presence of the inner ring (12) eliminates the need to subject the support arm (6) to thermal treatment, either in its entirety or in the vicinity of the outer ring (10). Furthermore, it is easier to carry out heat treatment on a small component such as the inner ring (12) than on a long element such as the support arm (6). The inner ring (12) may be attached to the support arm (6) by welding.

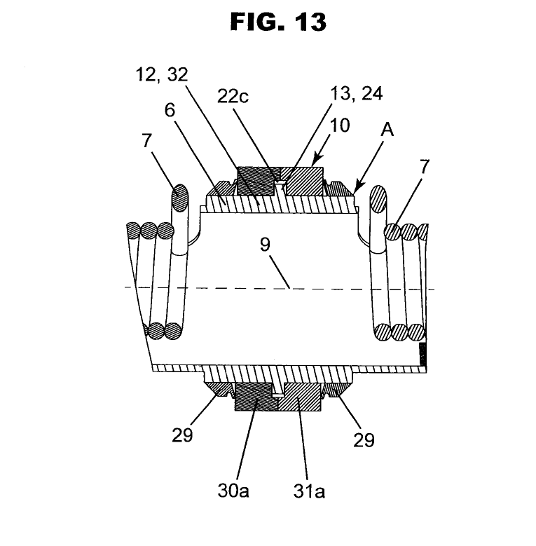

Nevertheless, according to a seventh embodiment variant shown in FIG. 13, it is still conceivable that the inner ring (12) of at least one of the at least first bearing (A) and second bearing (B) may be made of a shoulder (32) on the support arm (6). This feature eliminates the need to secure the inner ring (12) on the support arm (6) in a further operation, for example welding.

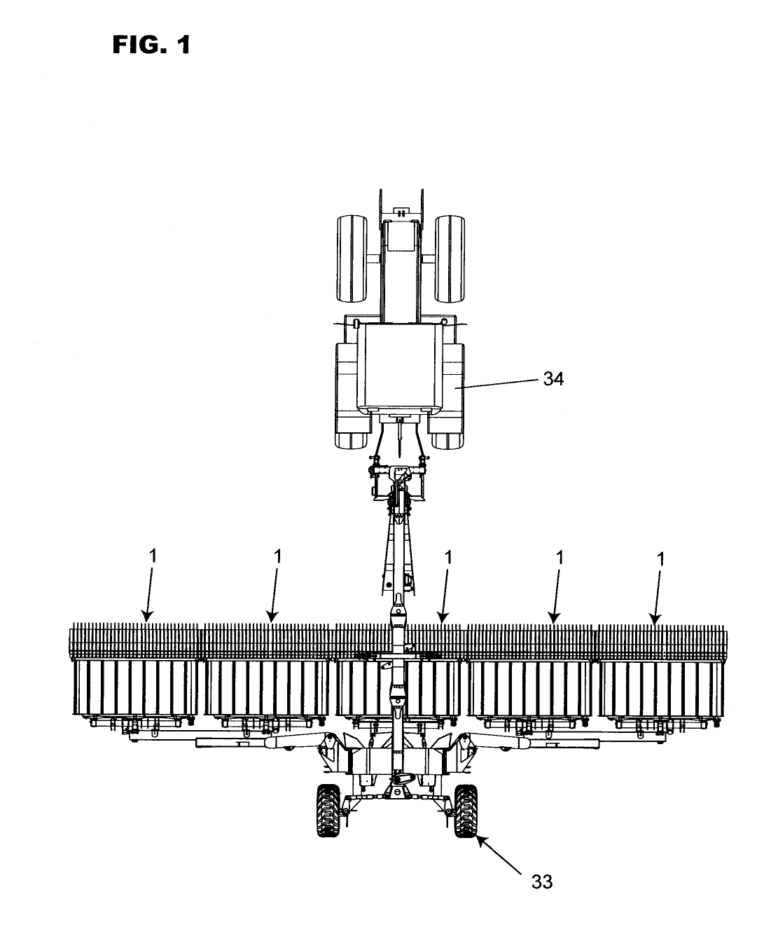

The pick-up device (1) according to the invention is intended to be mounted on an agricultural machine (33), either alone or in combination with other pick-up devices, which may or may not be in accordance with the invention. One of the agricultural machines concerned thereby is a machine for swathing products lying on the ground, and in particular a machine of such kind referred to by the name “Merger”. Such an agricultural machine (33) is illustrated in FIG. 1. It is designed to be hitched to a tractor (34) and comprises at least one pick-up that picks up the plants, and at least one device for moving laterally the picked up plants sideways. The pick-up may advantageously consist of a pick-up device (1) according to the invention. Such a device may also be used on any other harvesting machine such as a baler, a loader wagon or a chopper.

It is clear that the invention is not limited to the embodiments described above and illustrated in the attached figures. Modifications remain possible, particularly with regard to the constitution or number of the various elements, or by substituting technical equivalents, without thereby departing from the scope of protection.

1-20. (canceled)

21. A pick-up device comprising:
tools for raking and picking up products lying on the ground and which is configured to be mounted on an agricultural machine;
a rotating part including at least one support arm, the raking and picking up tools being attached to the at least one support arm, the at least one support arm configured to pivot about a rotation axis with respect to the rotating part by at least a first bearing and a second bearing, the at least first and second bearings each comprising an outer ring rigidly fastened to the rotating part and with respect to which outer ring the support arm is configured to pivot about the rotation axis,
wherein at least the first bearing comprises an inner ring, the inner ring configured to pivot about the rotation axis with respect to the outer ring, and the inner ring is rigidly fastened to the support arm,
and further comprising a stop means connecting the inner ring to the outer ring, the stop means limits displacement of the support arm with respect to the rotating part in a direction substantially parallel to the rotation axis to a small or nil value.

22. The pick-up device according to claim 21, wherein the inner ring extends between two faces, the outer ring extends between two faces, and the stop means is arranged between two closest faces of the faces in a direction substantially parallel to the rotation axis.

23. The pick-up device according to claim 21, wherein the stop means includes a two-part segment comprising two parts, and each of the two parts engages in a groove formed in the inner ring and in a groove formed in the outer ring.

24. The pick-up device according to claim 21, wherein the stop means includes an open segment and the open segment engages in a groove formed in the inner ring and in a groove formed in the outer ring.

25. The pick-up device according to claim 21, wherein the stop means includes a pin rigidly fastened to the inner ring, and the pin engages in a groove formed in the outer ring.

26. The pick-up device according to claim 21, wherein the stop means includes a pin rigidly fastened to the outer ring, and the pin engages in a groove formed in the inner ring.

27. The pick-up device according to claim 21, wherein the stop means includes a shoulder on the inner ring and the shoulder engages in a groove formed in the outer ring.

28. The pick-up device according to claim 23, wherein the segment comprises an anti-rotation means for limiting pivoting backlash of the segment about an axis substantially parallel to the rotation axis to a small or nil value.

29. The pick-up device according to claim 24, wherein the segment comprises an anti-rotation means for limiting pivoting backlash of the segment about an axis substantially parallel to the rotation axis to a small or nil value.

30. The pick-up device according to claim 28, wherein the anti-rotation means includes a teat which is rigidly fastened to the segment and engages in a hole made in the inner ring.

31. The pick-up device according to claim 29, wherein the anti-rotation means includes a teat which is rigidly fastened to the segment and engages in a hole made in the inner ring.

32. The pick-up device according to claim 28, wherein the means for preventing rotation includes a pin that passes through the segment and engages in a hole made in the inner ring.

33. The pick-up device according to claim 29, wherein the means for preventing rotation includes a pin that passes through the segment and engages in a hole made in the inner ring.

34. The pick-up device according to claim 21, wherein at least the second bearing comprises an inner ring, the inner ring can pivot with respect to the outer ring about the rotation axis, and the inner ring is rigidly fastened to the support arm.

35. The pick-up device according to claim 34, wherein the inner ring can freely move in the outer ring in a direction substantially parallel to the rotation axis.

36. The pick-up device according to claim 21, wherein at least one of the at least first bearing and second bearing comprises two seals, and each of the two seals rests against the outer ring of the at least first bearing or second bearing.

37. The pick-up device according to claim 36, wherein each of the two seals rests against the inner ring of the at least first bearing or second bearing.

38. The pick-up device according to claim 21, wherein the outer ring of at least one of the at least first bearing and second bearing comprises two sections that meet in a plane substantially perpendicular to the rotation axis.

39. The pick-up device according to claim 21, wherein the outer ring of at least one of the at least first bearing and second bearing comprises two sections that meet in a plane substantially parallel to the rotation axis.

40. The pick-up device according to claim 21, wherein the outer ring of at least one of the at least first bearing and second bearing includes a self-lubricating material.

41. The pick-up device according to claim 21, wherein the inner ring of at least one of the at least first bearing and second bearing is a part attached to the support arm.

42. The pick-up device according to claim 21, wherein the inner ring of at least one of the at least first bearing and second bearing includes a shoulder on the support arm.

43. An agricultural machine comprising at least one pick-up device according to claim 21.
